(19) United States
(12) Patent Application Publication
(10) Pub. No.: US 2010/0218384 A1
(43) Pub. Date: Sep. 2, 2010

(54) Cutting tool

(76) Inventors: Fran Marku, Wilmington, DE (US); Alban Kola, Wilmington, DE (US)

Correspondence Address: LITMAN LAW OFFICES, LTD., POST OFFICE BOX 41200, SOUTH STATION, ARLINGTON, VA, 22204, US

(21) Appl. No.: 12/379,770

(22) Filed: Feb. 27, 2009

(51) Int. Cl. B25D 3/00; B26B 9/00

(52) U.S. Cl. 30/167; 30/353

(57) ABSTRACT

The cutting tool includes a rigid, elongate, axially and laterally symmetrical bar having a plurality of parallel cutting edges and a handle portion at each end thereof. The tool has a plurality of cutting blades having generally flat faces therebetween. The edges are blunted at each end of the tool to allow the end portions to serve as handles, thus facilitating manipulation of the tool. Each handle portion includes at least one flat face that is coplanar with a face extending from at least one cutting edge. This allows the tool to be stroked along a panel surface to trim a veneer edge therefrom with the plane of the cutting blade remaining flush against the surface of the panel during the cutting operation and not being lifted from the surface due to the thickness of the handle protruding beyond the plane of the cutting blade.

### BACKGROUND OF THE INVENTION

1. Field of the Invention

The present invention relates generally to hand tools, and more particularly to an elongate cutting tool having a plurality of parallel cutting edges and a handle on each end.

2. Description of the Related Art

Most fine tabletops, cabinetry and the like include thin veneer surfaces along the exposed surfaces thereof. Such veneer is generally cut to slightly greater width than required and glued to the surface of the panel, with the finished dimension then trimmed from the greater width after the adhesive has set or cured.

Accordingly, various specialized tools have been developed for cutting or trimming unfinished veneer edges. The present inventors have found that while these tools can trim rough edges of veneer from a surface, they generally are not any more efficient than a non-specialized tool used for such purpose. Most such tools have but a single cutting edge, requiring relatively frequent sharpening. Other specialized tools include channels adapted to run along the edge of a veneered panel to trim the rough veneer edges. These tools are either not adaptable to panels of different thicknesses, or require adjustment to fit over the edges of panels of different thicknesses to trim the veneer edges therealong. Such specialized tools cannot trim the veneer along an edge of a cabinet or the like, having relatively wide and extensive veneered panels meeting along a common edge.

Thus, a cutting tool solving the aforementioned problems is desired.

### SUMMARY OF THE INVENTION

The cutting tool includes a rigid, elongate, laterally symmetrical bar having a plurality of parallel cutting edges and a handle portion at each end thereof. In a most preferred embodiment, the tool has a triangular cross section with three acute edges defining three faces therebetween. The edges are blunted along each end portion of the bar to allow the end portions to serve as handles, thus facilitating manipulation of the tool.

The handle portion includes at least one flat face that is coplanar with a face extending from at least one cutting edge. This allows the tool to be stroked or run along the surface of a panel to trim a veneer edge therefrom, with the plane of the cutting blade remaining flush against the surface of the panel during the cutting operation and not being lifted from the surface due to the thickness of the handle protruding beyond the plane of the cutting blade. In some embodiments, alternative cross sections and numbers of cutting edges or blades are provided, and handgrip grooves are formed substantially along the length of the tool, including at least most of the handle portions thereof.

These and other features of the present invention will become readily apparent upon further review of the following specification and drawings.

### BRIEF DESCRIPTION OF THE DRAWINGS

FIG. 1 is an environmental, perspective view of a cutting tool according to the present invention, showing its operation in trimming veneer.

FIG. 2 is an environmental perspective view similar to that of FIG. 1, showing the reversibility of the tool.

FIG. 3 is an environmental end elevation view of the cutting tool of FIG. 1, showing its rotation for using a different blade edge.

FIG. 4 is an end elevation view in section of the cutting tool of FIGS. 1 through 3, showing the handgrip grooves formed along each side.

FIG. 5 is an end elevation view in section of an alternative embodiment of a cutting tool according to the present invention having differently shaped handgrip grooves from those of the embodiment of FIGS. 1 through 4.

FIG. 6 is an end elevation view in section of another alternative embodiment of a cutting tool according to the present invention having differently shaped handgrip grooves from those of the embodiments of FIGS. 1 through 5.

FIG. 7 is a partial perspective view of still another alternative cutting tool configuration according to the present invention, showing details thereof.

FIG. 8 is a partial perspective view of yet another alternative cutting tool configuration according to the present invention, showing details thereof.

Similar reference characters denote corresponding features consistently throughout the attached drawings.

### DETAILED DESCRIPTION OF THE PREFERRED EMBODIMENTS

The cutting tool is a rigid, elongate bar with a plurality of cutting edges disposed therealong and at least one generally planar face extending between the adjacent cutting edges. The tool is particularly well suited for trimming unfinished veneer edges from veneer covered panels during their manufacture, but may be used for various other cutting and trimming operations as well.

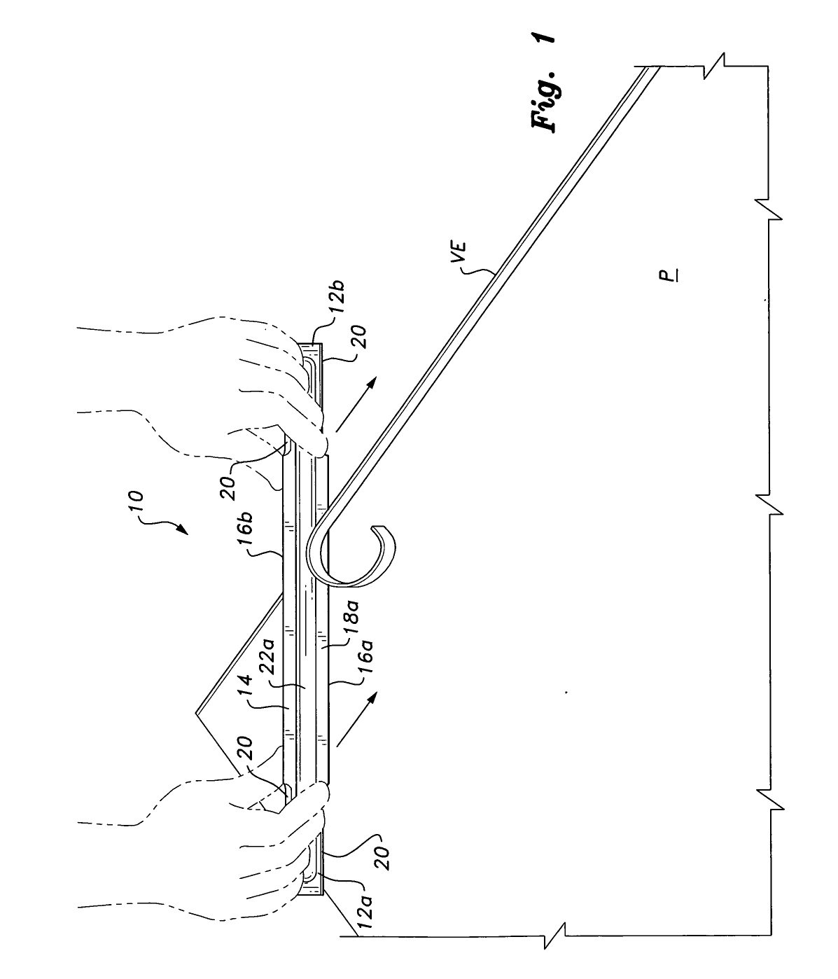

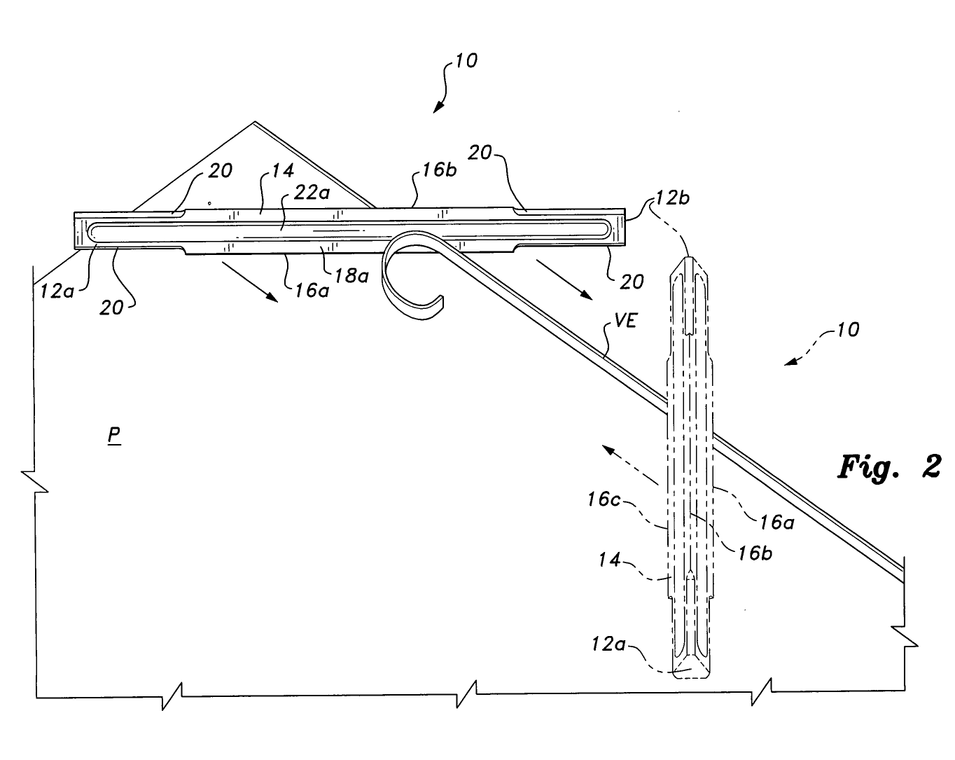

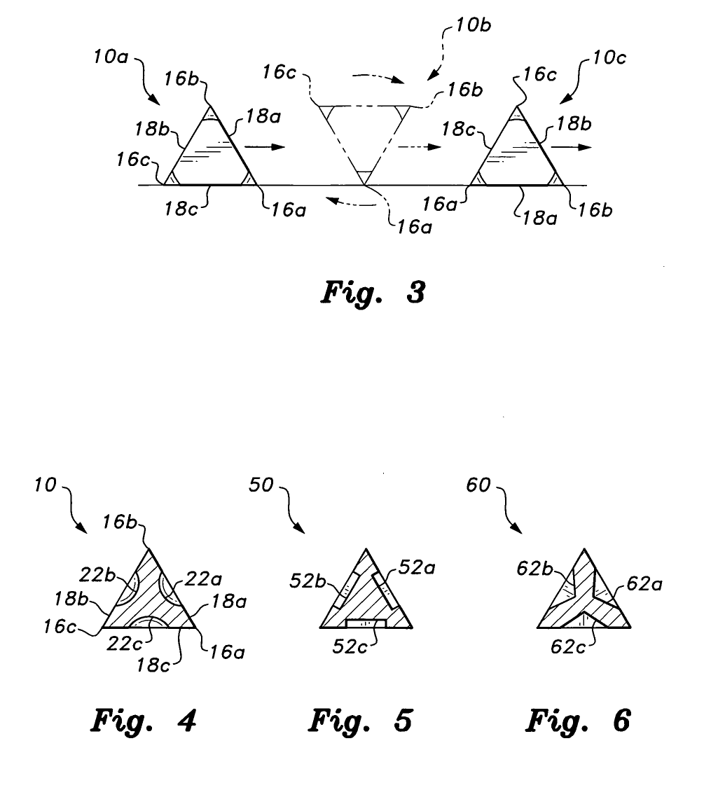

FIG. 1 of the drawings provides an environmental perspective view of a first embodiment of the cutting tool, designated as cutting tool 10, with FIGS. 2 and 3 illustrating further use of the tool. The tool 10 is a rigid, elongate, and laterally symmetrical bar with mutually opposed first and second handle ends or portions 12a, 12b and a considerably longer working portion 14 disposed therebetween. As the tool 10 is adapted for working with its length oriented generally across the direction of travel, it should be noted that the term “laterally symmetrical” means symmetry between the two handle ends 12a, 12b of the tool, with the two end portions being mirror images of one another.

The tool 10 of FIGS. 1 through 3 has a polygonal cross section, or more specifically an axially symmetrical equilateral triangular cross section, as shown in FIG. 3. The tool 10 (or 10a through 10c, as shown in FIG. 3 to indicate the three changes of orientation in that Fig.) includes three parallel acute cutting edges, respectively 16a, 16b, and 16c. These edges 16a through 16c extend along the length of the working portion 14 and define three equal width flat faces therebetween, respectively 18a, 18b, and 18c. This enables the tool 10 to be rotated about its lateral or elongate axis to use any of the three cutting edges 16a, 16b, or 16c as desired, thereby increasing the time between required sharpening operations for the tool.

The flat faces 18a through 18c extend the entire length of the working portion 14 of the tool and continue along the lengths of each of the handle end portions 12 and 12b. In other words, each of the flat faces 18a through 18c is coplanar from the very end of each handgrip end 12a or 12b to the opposite handgrip end 12a or 12b. This allows the cutting edge of the tool 10 to remain flush with the flat surface over which the tool is being guided, without a thicker handle portion lifting the tool at one end and producing an angle between the cutting blade and the underlying surface. It will be noted that the cutting edges 16a through 16c do not extend for the entire length of the tool. Rather, each of the cutting edges terminates at a blunted edge 20 that extends along the respective handle end portion 12a and 12b. This facilitates handling the tool 10 as shown in FIG. 1, with the user's fingers being placed outboard of the working portion 14 and along the handle portions 12a, 12b with their blunted edges 20.

The tool 10 further preferably includes handgrip grooves, respectively 22a through 22c, with each groove extending along the corresponding face 18a through 18c for the entire length of the working portion 14 and continuing for most of the length of each of the handle end portions 12a, 12b. These handgrip grooves 22a through 22c facilitate the manipulation of the tool 10, particularly those portions of the groove extending into the handle end portions of the tool. The grooves 22a through 22c may have concave curved cross sections, as shown in the tool 10 of FIGS. 1 through 4, or may comprise other cross sectional shapes as desired. For example, the cutting tool 50 of FIG. 5 may have grooves 52a through 52c of a shallow rectangular configuration, and the cutting tool 60 of FIG. 6 may have shallow triangular grooves. Obviously, other groove shapes and depths may be provided as desired.

The cutting tool 10 (and cutting tools 50 and 60) is used generally as shown in FIGS. 1 through 3 of the drawings. Initially, a rough veneer edge VE extends upwardly from a panel P, as shown in FIGS. 1 and 2. The tool 10 is placed atop the panel P at an obtuse angle to the panel edge with one of its flat surfaces, e.g., surface 18c, resting atop the panel P, generally as shown in FIGS. 1 and 2. The tool 10 is then stroked along the edge of the panel P with the tool angled to face inwardly toward the center of the panel P, with the leading cutting edge, e.g., edge 16a as shown in FIGS. 1 and 2, trimming the veneer edge VE flush with the panel P to produce a finished panel.

The tool 10 is preferably used at an angle to the veneer line, as shown in FIGS. 1 and 2 in order to produce a force component toward the panel, i.e., pushing the veneer toward the panel. This prevents the veneer from being peeled away from the panel during the cutting operation. If the blade becomes dull or the direction of the cutting operation must be reversed, the motion of the tool 10 is merely reversed and the angle turned to produce an obtuse angle in the opposite direction, as shown by the tool 10 in broken lines in FIG. 2. This might occur when the first cutting edge 16a becomes dull and a fresh cutting edge is needed. As there is a cutting edge along each apex of the tool, the direction of motion of the tool need only be reversed to apply a fresh cutting edge to the work.

The provision of a polygonal shape with each apex having a separate cutting edge provides even further benefits for the tool 10. FIG. 3 illustrates how the tool 10 may be rotated about its lateral axis to provide a fresh leading or working cutting edge at each 120 degrees of rotation. Initially, the first cutting edge 16a is leading, as shown in the leftmost portion of FIG. 3. As the cutting edge 16a becomes dull or worn, the tool 10 may be rotated about its lateral axis to position a different cutting edge at the front of the tool movement. The intermediate position in FIG. 3, in broken lines, shows the tool rotated 60 degrees clockwise from the initial position to the left side of FIG. 3. The second cutting edge 16b is being rotated to the leading position, i.e., to the right edge of the tool as the tool is advanced from left to right in FIG. 3. Finally, the tool rotation is continued through another 60 degrees to the position shown to the right side of FIG. 3 in solid lines, with the second cutting edge 16b as the leading or working edge. This procedure may be repeated as the second cutting edge 16b is dulled, rotating the tool 10 through another 120 degrees clockwise to position the third cutting edge 16c as the leading or working cutting edge.

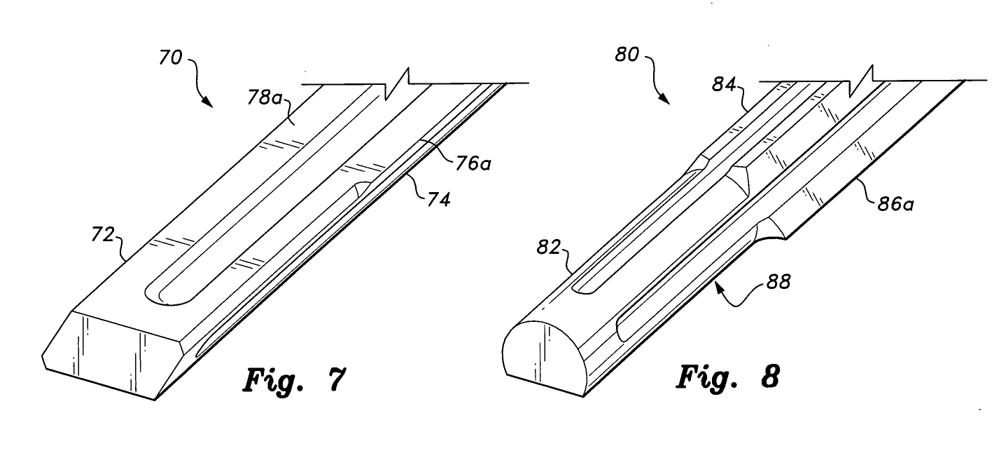

FIGS. 7 and 8 illustrate additional embodiments of the cutting tool, having other than triangular cross sections. The tool 70 of FIG. 7 has a cross section of parallelogram configuration, as can be seen from the end view of the handle portion 72. This configuration provides only two acute cutting edges, one of which is visible (cutting edge 76a) in the perspective view of FIG. 7. However, the tool 70 still retains the critical features of the invention, i.e., multiple cutting edges having flat faces extending therefrom, with each of the faces extending as coplanar surfaces from the extreme end of each handle portion and along the entire working portion of the tool, as exemplified by the first face 78a shown extending across the working portion 74 and handle end 72a of the tool 70 in FIG. 7. The opposite cutting edge (not shown) of the tool 70 is used by rotating the tool by 180 degrees about its elongate lateral axis, with the first face 78a and its cutting edge 76a then being positioned downwardly to rest atop the work surface or panel.

FIG. 8 illustrates still another cutting tool embodiment. The cutting tool 80 of FIG. 8 has a trapezoidal cross section, as is evident along the working portion 84 of the tool. Two acute cutting edges are provided along he working portion of the tool, with the first cutting edge 86a being visible in the perspective view of FIG. 8. This tool configuration may be considered as related to the triangular cross section tool 10 of FIGS. 1 through 3, but having one truncated apex. This results in both cutting edges being in the same plane, and thus the tool 80 is not rotated about its elongate lateral axis to use a fresh cutting blade. Rather, the tool 80 may be reversed in direction or turned around end-to-end to use the second cutting edge (not shown). As the tool 80 need not be turned over or rotated to use a different cutting blade edge, the surface(s) of the handle need not be flush with the surfaces of the working portion 84 of the tool. The exemplary handle portion 82 of the tool 80 of FIG. 8 has a semicircular cross section, with only the single flat face 88 (facing downwardly in FIG. 8) extending between the first cutting edge 86a and its opposite cutting edge (not shown) being coplanar across the flat of the handle end portion 82a and the working portion 84 of the tool 80.

A number of different variations on the above polygonal cross section cutting tools may be provided, as desired. The equilateral triangular configuration of the tools 10, 50, and 60 of FIGS. 1 through 5 is preferable, as this configuration provides three separate acute cutting edges, with each edge having an included angle of 60 degrees. However, other triangular cross sections may be provided as desired, e.g., a shallow isosceles triangle having one shallower apex and two more acutely angled cutting edges, etc. Also, it will be seen that the two examples of FIGS. 7 and 8 are but two of a large number of different polygonal cross-sectional shapes that might be provided for the cutting tool. However, in any of the embodiments of the cutting tool, at least two coplanar cutting edges are provided, with a flat face extending therefrom and further extending along a coplanar surface of each of the handle ends of the tool. The result is a cutting tool that places at least one cutting edge flush with the surface of a panel, enabling an upstanding edge of material to be cut or trimmed flush with the panel with one pass of the tool. The result is a tool that will prove most valuable in the cabinetry field for trimming veneer, but which will also have use in many other areas as well.

It is to be understood that the present invention is not limited to the embodiments described above, but encompasses any and all embodiments within the scope of-the, following claims.

We claim:

1. A cutting tool, comprising:
a rigid, elongate, axially symmetrical bar having mutually opposed first and second ends the bar defining a polygonal cross section; and
a plurality of parallel acute cutting edges disposed along at least a majority of the length of the bar, at least one substantially flat face of the bar being disposed between each of the adjacent cutting edges.

2. The cutting tool according to claim 1, wherein:
the bar is laterally symmetrical, having mutually opposed first and second handle end portions and a working portion disposed therebetween, the plurality of acute cutting edges extending along the working portion;
the at least one flat face is disposed along the working portion of the bar and extends along each of the handle end portions, the flat face being coplanar across the working portion and the handle end portions; and
each of the cutting edges terminates at a blunted edge extending along each of the handle end portions.

3. The cutting tool according to claim 1, further comprising:
the bar is laterally symmetrical, having mutually opposed first and second handle end portions and a working portion disposed therebetween, the plurality of acute cutting edges extending along the working portion;
the at least one flat face is disposed along the working portion of the bar and extends along each of the handle end portions; and
a handgrip groove is disposed along the at least one face and extends the entire length of the working portion of the bar and at least substantially the length of each of the handle end portions thereof.

4. The cutting tool according to claim 1, wherein the bar forms an equilateral triangle in cross section.

5. The cutting tool according to claim 1, wherein the bar forms a parallelogram in cross section.

6. The cutting tool according to claim 1, wherein the bar is a trapezoidal in cross section.

7. A cutting tool, comprising:
a rigid, elongate, laterally symmetrical bar having mutually opposed first and second handle end portions, a working portion disposed therebetween, and a plurality of acute cutting edges extending along the working portion; and
at least one substantially flat face disposed along the working portion of the bar and extending along each of the handle end portions, the flat face being coplanar across the working portion and the handle end portions, each of the cutting edges terminating at a blunted edge extending along each of the handle end portions.

8. The cutting tool according to claim 7, wherein:
the bar is axially symmetrical symmetry, defining a polygonal cross section; and
a single substantially flat face is disposed between each of the adjacent cutting edges.

9. The cutting tool according to claim 7, wherein:
the bar has a plurality of flat faces disposed along the working portion and extending along each of the handle end portions; and
the bar has a handgrip groove disposed along each of the faces, the groove extending the entire length of the working portion of the bar and at least substantially the length of each of the handle end portions thereof.

10. The cutting tool according to claim 7, wherein the bar forms an equilateral triangle in cross section.

11. The cutting tool according to claim 7, further comprising the bar has a parallelogram cross section.

12. The cutting tool according to claim 7, further comprising the bar is a trapezoidal in cross section.

13. A cutting tool, comprising:
a rigid, elongate bar having mutually opposed first and second handle end portions, and a working portion disposed between the handle end portions;
a plurality of acute cutting edges extending along the working portion; and
a plurality of flat faces disposed along the working portion of the bar and extending along each of the handle end portions, a handgrip groove being disposed along each of the faces and extending the entire length of the working portion of the bar and at least substantially the length of each of the handle end portions thereof.

14. The cutting tool according to claim 13, wherein:
the bar is axially symmetrical and defines a polygonal cross section; and
a single substantially flat face is disposed between each of the adjacent cutting edges.

15. The cutting tool according to claim 13, wherein:
the bar is laterally symmetrical;
each of the flat faces is coplanar across the working portion and the handle end portions; and
each of the cutting edges terminates at a blunted edge extending along each of the handle end portions.

16. The cutting tool according to claim 13, wherein the bar forms an equilateral triangle in cross section.

17. The cutting tool according to claim 13, wherein the bar forms a parallelogram in cross section.

18. The cutting tool according to claim 13, wherein the bar is trapezoidal in cross section.
